(19) United States
(12) Patent Application Publication
(10) Pub. No.: US 2025/0272734 A1
(43) Pub. Date: Aug. 28, 2025

(54) Computer-Implemented Method For Assessing Spinning Mills

(71) Applicant: Uster Technologies AG, Uster (CH)

(72) Inventors: Isik TIRAMIS, Uster (CH); Serap DÖNMEZ KRETZSCHMAR, Lachen (CH); Martin NORDIO, Zurich (CH); Jia TAN, Suzhou (CN); Jian GAO, Jingjiang City (CN)

(73) Assignee: Uster Technologies AG, Uster (CH)

(21) Appl. No.: 18/858,313

(22) PCT Filed: Apr. 19, 2023
(86) PCT No.: PCT/IB2023/000141

§ 371 Date: Oct. 19, 2024

(30) Foreign Application Priority Data
Apr. 21, 2022 (CN) 202210422805.X

(51) Int. Cl. G06Q 30/0601; G06Q 10/0639; G06Q 30/018

(52) U.S. Cl. CPC G06Q 30/0627; G06Q 10/06395; G06Q 30/018

(57) ABSTRACT

The computer-implemented method serves for assessing spinning mills. A server computer system receives from a spinning mill having produced a yarn package a set of measured values for at least one yarn-quality parameter measured for yarn on the yarn package. It assigns to the set of measured values a mill identifier for the respective spinning mill and stores in a database the set of measured values together with the assigned mill identifier. These steps are repeated for at least one other spinning mill. The server computer system produces a ranking of the spinning mills according to the sets of measured values and the mill identifiers. It transmits the ranking to a client computer. The method facilitates an efficient trading of yarn packages.

### FIELD OF THE INVENTION

The present invention lies in the fields of yarn production, yarn-quality determination and yarn trading. It relates to a computer-implemented method and a server computer system for assessing spinning mills, according to the independent patent claims.

### DESCRIPTION OF THE PRIOR ART

WO-2019/227241 A1 discloses a method for operating a ring spinning system which contains a ring spinning machine with a plurality of spinning positions and a winding machine with a plurality of winding positions. Yarn spun on the spinning machine is transported on cops to the winding machine. There, it is wound from the cop onto a larger yarn package. Values of yarn parameters are determined by a yarn clearer during the winding process on the winding machine and stored as yarn data.

EP-0,854,107 A1 discloses a yarn-package grade determination system. The system comprises a yarn quality monitoring means such as a tension controller provided for each unit in a draw texturing machine to constantly monitor data on the quality of yarn processed into packages, a transfer means for transferring packages ejected from the machine to the exterior while identifying the sources of the packages, an inspection means for inspecting, at least, weight or appearance of the package transferred by the transfer means, and a grade determination means for combining data on each package from the yarn quality monitoring means with data on each package from the inspection means to determine the grade of the package. The grades are used for the processing of the packages within the draw texturing machine factory.

CN-110,033,350 A discloses a textile fabric mobile internet transaction platform which comprises an online server, and an application program end, a direct marketing end and a big database which are in communication connection with the online server. The application program end is at least integrated with a supply module and a purchasing module. The basic parameter information of the fabric product is uploaded to an online server, and a unique two-dimensional code is generated. The purchasing module is used for providing classification service, retrieval service and purchasing service for the purchaser. The direct marketing end comprises a fabric offline warehouse for placing and attaching a label. The big database stores the data generated in the operation process of the platform in a classified manner. The online server provides the data interaction and synchronization and pushes different contents according to the trend of the data.

In order to compare the quality level of one textile mill with another's, a common “quality language” is needed. Worldwide accepted quality benchmarks or quality references in the textile industry are the USTERR STATISTICS; see USTERR NEWS BULLETIN Nos. 49 and 51, Uster Technologies AG, November 2012 and October 2018, respectively. The USTERR STATISTICS are a comprehensive statistical survey of the quality of textile materials produced worldwide. They essentially contain statistical data in the form of graphs with percentile curves for numerous parameters and textile materials. These graphical cumulative frequency representations statistically indicate the extent by which a certain textile material is above or below a certain quality-parameter value. For instance, a percentile value of 25 means that 25% of the textile mills worldwide produce the respective product with the same or lower value of the respective quality parameter. Numerical editions, as opposed to graphical, are also available. The USTERR STATISTICS are made available by Uster Technologies AG via the internet (https://www.uster.com/value-added-services/uster-statistics/).

Yarn is bought from spinning mills mainly by weaving and knitting mills. Yarn buyers want to source yarn efficiently in the right amount and quality for their downstream application. Nowadays, before buying a large batch of yarn packages, they first buy a small sample of packages of a certain yarn type, for which they make acceptance trials. This is time and cost intensive, and, moreover, unreliable due to the small sample size. Sometimes yarn packages or whole lots have to be returned due to their unsatisfactory quality and/or consistency, and sometimes orders are not placed due to disappointing trial results. Such returns of yarn packages or lots are often the only feedback a spinning mill gets on the produced yarn quality.

### SUMMARY OF THE INVENTION

It is an object of the present invention to provide the technical infrastructure that avoids the drawbacks of the prior art and thus facilitates an efficient and more environmentally friendly trading of yarn packages. The computer-implemented method and server computer system shall allow yarn buyers to objectively assess various spinning mills and, based on the assessment, purchase exactly the yarn quality needed. They shall make costly and lengthy acceptance trials obsolete. With no or less acceptance trials, less samples have to be transported and less material is wasted. Wasted shipping of yarn-package samples and/or whole yarn-package lots shall be avoided. Spinning mills shall get early feedback on the produced yarn quality and on possible yarn-quality outliers, so that they can take the technical measures for improving the yarn quality and consistency.

These and other objects are solved by the computer-implemented method and server computer system as defined in the independent claims. Advantageous embodiments are specified in the dependent claims.

The computer-implemented method according to the invention is for assessing spinning mills producing yarn packages on yarn-winding machines. The method comprises the steps of: receiving by a server computer system via a global communication network from a spinning mill having produced a yarn package on a yarn-winding machine a set of measured values for at least one yarn-quality parameter measured for yarn on the yarn package by at least one sensor on the yarn-winding machine; assigning by the server computer system to the set of measured values a mill identifier for the respective spinning mill; storing in a database on the server computer system the set of measured values together with the assigned mill identifier; repeating the preceding steps for at least one other spinning mill; producing by the server computer system a ranking of the spinning mills according to the sets of measured values and the mill identifiers assigned to them; and transmitting the ranking from the server computer system via a global communication network to a client computer.

According to one embodiment of the invention, the set of measured values is for at least one parameter from the following set: coefficient of variation of the yarn mass, coefficient of variation of the yarn diameter, hairiness, number of thick places, number of thin places, number of periodic yarn defects, number of yarn count variations, number of foreign matters, number of splices.

One embodiment of the invention further comprises the steps of: receiving by the server computer system via the global communication network from the spinning mill further information on the yarn package; assigning by the server computer system to the further information the mill identifier for the respective spinning mill; and storing in the database the further information together with the assigned mill identifier.

According to one embodiment of the invention, the further information is from the following set: yarn count, yarn material, fiber processing system, spinning system, envisaged application, amount of yarn packages available, temporal availability of the yarn package, price of the yarn package.

One embodiment of the invention further comprises the steps of: assigning by the server computer system to the received set of measured values a package identifier for the respective yarn package; and storing in the database the package identifier together with the set of measured values and the mill identifier. Preferably, this embodiment further comprises the steps of: receiving by the server computer system via the global communication network from the client computer a purchase request containing yarn specifications; retrieving from the database, using the package identifiers and the mill identifiers, sets of yarn packages such that the further information matches the yarn specifications for all packages of each of the retrieved sets of yarn packages; and producing by the server computer system the ranking only of those spinning mills that produced the retrieved sets of yarn packages.

According to one embodiment of the invention, the ranking is produced based on all sets of measured values stored in the database, based on a certain number of most recent sets of measured values, or based on most recent sets of measured values measured in a certain period.

According to one embodiment of the invention, the ranking is produced on an ordinal scale or on a metric scale.

According to one embodiment of the invention, the ranking is in the form of measured values assigned to the spinning mills, in the form of quantiles or percentiles assigned to the spinning mills, in the form of ordinal numbers assigned to the spinning mills, and/or in the form of classes into which the spinning mills are classified.

According to one embodiment of the invention, before storing the set of measured values in the database, the set of measured values is compared by the server computer system with sets of measured values having the same assigned mill identifier, and in case of a significant deviation, the set of measured values is marked as an outlier and is not considered in the ranking. Upon occurrence of an outlier, an outlier message identifying the outlier can be transmitted from the server computer system via the global communication network to the respective spinning mill.

One embodiment of the invention further comprises the steps of: receiving by the server computer system via the global communication network from the spinning mill values of at least one ambient parameter characteristic for an ambient condition of a location and a time of winding the yarn package; correcting by the server computer system the received set of measured values to predefined ambient conditions based on the received value of the at least one ambient parameter, thus generating a set of corrected values; and replacing in the method according to any one of the preceding claims the set of measured values by the set of corrected values.

The invention further encompasses a server computer system comprising means for carrying out one of the methods according to the invention as described above.

The invention also encompasses a computer program having instructions which when executed by a server computer system cause the server computer system to perform one of the methods according to the invention as described above.

The server computer system according to the invention is for assessing spinning mills producing yarn packages on yarn-winding machines. The server computer system comprises: a receiver for receiving via a global communication network from at least two spinning mills having produced yarn packages on yarn winding machines sets of measured values for at least one yarn-quality parameter measured for yarn on each of the yarn packages by at least one sensor on the respective yarn-winding machine; a processor configured to assign to each set of measured values a mill identifier for the respective spinning mill; a memory for storing in a database the sets of measured values together with the assigned mill identifiers; a processor configured to produce a ranking of the at least two spinning mills according to the sets of measured values and the mill identifiers assigned to them; and a transmitter for transmitting the ranking via a global communication network to a client computer.

The “set of measured values” can consist of any natural number of measured values including one.

In this document, an “ordinal scale” is a variable measurement scale used to simply depict the order of variables and not the difference between each of the variables. A “metric scale” is a variable measurement scale that not only produces the order of variables but also makes the difference between variables known. The term “metric scale” can be subdivided into an “interval scale”, which does not indicate any zero point, and a “ratio scale”, which additionally provides information on the value of true zero.

In this document, the term “yarn-winding machine” or “winding machine” denotes any machine in a spinning mill that winds yarn onto a yarn package larger than a cop. In the ring-spinning process, this is typically a stand-alone winding machine. In spinning processes other than ring spinning (e.g., compact, rotor or air-jet spinning), the spun yarn is wound directly onto a yarn package on the spinning machine. Such spinning machines other than ring-spinning machines are also referred to as “yarn-winding machines” or “winding machines” in this document.

A “server computer system” as used in this document may consist of several pieces of computer hardware suitably connected for communicating with each other. Such pieces of computer hardware need not necessarily be located at the same site but may rather be distributed over different locations.

A “buyer” as used in this document can be an end user of the yarn, such as a weaving or knitting mill, or any intermediary who resells or conveys the yarn to another buyer. In the latter case, the intermediary need not perform a monetary transaction in the strict sense of buying.

The present invention facilitates an efficient trading of yarn packages. Thanks to it, yarn buyers can objectively assess various spinning mills and, based on the assessment, purchase exactly the yarn quality needed. Every yarn buyer gets information on the quality and consistency of various suppliers offering yarn packages. Thus, costly and lengthy acceptance trials are no longer necessary or substantially reduced. Since the consistency of each supplier is being measured and communicated to the buyers, unpleasant surprises in the form of outlier packages within a package lot can be excluded. A wasted shipping of yarn-package samples and/or whole yarn-package lots, as well as returns of yarn packages of unsatisfactory quality, are thus avoided or drastically minimized. Insofar, the invention respects the environment. Yarn quality and consistency of individual spinning mills and of the spinning industry in general are improved, since spinning mills get early feedback on the produced yarn quality and on possible yarn-quality outliers.

### BRIEF DESCRIPTION OF THE DRAWINGS

In the following, the invention is explained in detail based on the drawings.

FIG. 1 schematically shows a server computer system according to the invention, together with its environment.

FIG. 2 schematically shows tables of a database implemented in the server computer system according to the invention.

FIG. 3 shows an example of a user interface displayed on a client computer.

### IMPLEMENTATION OF THE INVENTION

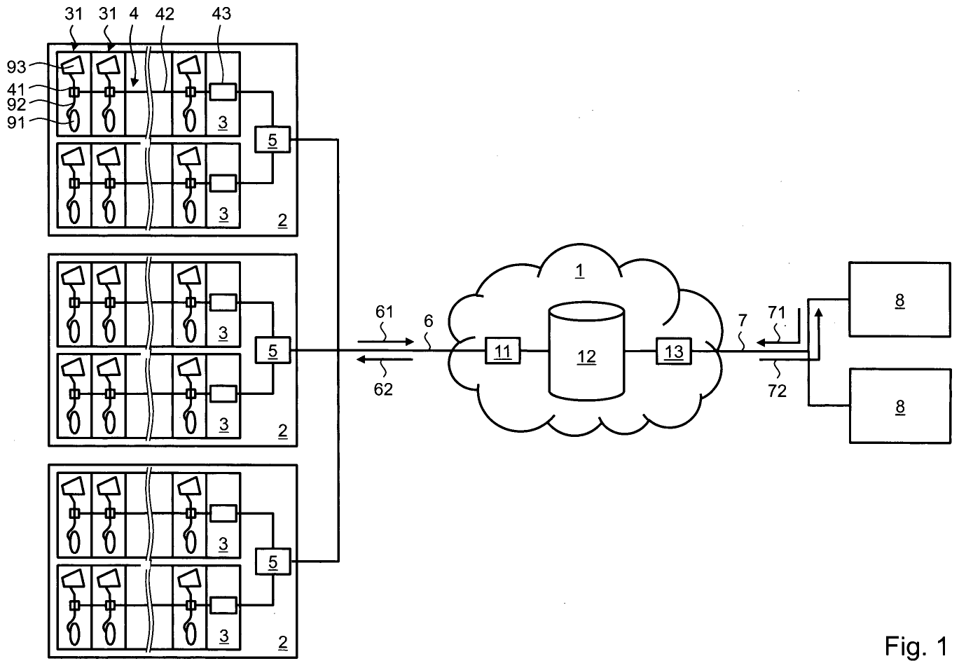

FIG. 1 schematically shows a server computer system 1 according to the invention, together with its environment. The server computer system 1 is preferably realized by means of cloud computing, i.e., employs remote shared computer resources, and is therefore symbolized by a cloud in FIG. 1. The server computer system 1 is connected via a global communication network 6 such as the world wide web with a plurality of spinning mills 2. The server computer system 1 is also connected via a global communication network 7 such as the world wide web with a plurality of client computers 8, each of the client computers 8 being operated by a yarn buyer. Only three spinning mills 2 and two client computers 8 are drawn in FIG. 1 for the sake of simplicity; however, in practice the numbers of spinning mills 2 and client computers 8 can be significantly higher.

For communicating with the spinning mills 2 and the client computers 8, the server computer system 1 is equipped with suitable communication means 11, 13. The communication means 11, 13 include hardware, such as routers, and software, such as application programming interfaces (APIs). They act as a receiver and/or transmitter each.

The spinning mills 2 produce yarns 92. In the ring-spinning process, the spun yarn 92 is wound onto relatively small cops 91. The cops 91 are transported from ring-spinning machines (not shown) to winding machines 3. Each winding machine 3 has a large number of winding positions 31. At each winding position 31, yarn 92 is wound from several cops 91 onto a larger yarn package 93, which is typically a cross-wound bobbin. Alternatively, in spinning processes other than ring spinning, the spun yarn is wound directly onto a yarn package on the spinning machine. Such spinning machines, as well as the stand-alone winding machines 3 used in ring spinning, are referred to as “yarn-winding machines” or “winding machines” in this document.

The winding machine 3 is equipped with a yarn monitoring system 4 for monitoring properties of the yarn 92. The yarn monitoring system 4 can, for example, be designed as a yarn clearing system with a yarn sensor 41 at each of the winding positions 31. The yarn sensor 41 measures values of at least one yarn-quality parameter of the yarn wound on the yarn package. Each yarn sensor 41 is connected to a yarn monitoring control unit 43 via a wired or wireless data line 42. The yarn sensor 41 transmits values of the at least one measured value to the yarn monitoring control unit 43 via the data line 42. The yarn monitoring control unit 43 receives the measured values and stores them together with associated information that identifies the corresponding yarn package 93. Each yarn sensor 41 can be assigned a yarn cutting unit (not drawn) that removes impermissible yarn defects from the yarn 92.

Examples of the yarn-quality parameters are a coefficient of variation of the yarn mass, a coefficient of variation of the yarn diameter, a hairiness, a number of thick places, a number of thin places, a number of periodic yarn defects, a number of yarn count variations, a number of foreign matters and a number of splices. Such yarn-quality parameters can be indicated per unit length of the yarn 92, per unit mass of the yarn 92 and/or per yarn package 93. For the purposes of the present invention, the values of the yarn-quality parameters of the yarn wound on the yarn package 93 are relevant and thus stored. These values generally differ from those of the yarn on the cop 91 due to the yarn-clearing function performed by the yarn-clearing system 4.

Apart from the yarn-quality parameters, further information on the yarn package 93 can be used for characterizing the yarn 92 on the yarn package 93. Such further information can be technical and/or non-technical. It may comprise, e.g., the following:
Yarn count, e.g., Ne 20, Ne 30, etc.;
Yarn material, e.g., cotton, polyester, viscose, modal, wool, etc.;
Fiber-processing system, e.g., carding or combing;
Spinning system, e.g., ring-spun yarn, compact yarn, rotor yarn, air-jet yarn, etc.;
Envisaged application, e.g., knitting or weaving;
Amount of yarn 92 on the yarn package 93, e.g., 10 kg or 500 km;
Temporal availability of the yarn 92, e.g., deliverable within one week or within two weeks, etc.;
Price of the yarn 92;
Producer of the yarn 92; and/or
Yarn brand.

The measured values of yarn-quality parameters, and optionally the further information on the yarn package 93 are transmitted from each of the spinning mills 2 via the global communication network 6 to the server computer system 1, which data transmission is indicated by an arrow 61 in FIG. 1. For this purpose, all yarn monitoring control units 43 of the spinning mill 2 can be connected to a cloud connector 5 connected to the server computer system 1 via the global communication network 6. The server computer system 1 receives the values measured for each yarn package 31 as a set of measured values.

The server computer system 1 assigns to the received set of measured values a mill identifier for the respective spinning mill 2 that produced the yarn package 93. The received set of measured values together with the assigned mill identifier is stored in a database 12 on the server computer system 1.

In a preferred embodiment of the invention, the server computer system 1 additionally assigns to the received set of measured values and optionally to the received further information a package identifier for the respective yarn package 93. The assigned package identifier and is also stored in the database 12.

The steps of receiving the set of measured values, assigning to the set of measured values a mill identifier, and storing the set of measured values together with the assigned mill identifier are repeated for at least one other spinning mill 2. Thus, the database 12 contains sets of measured values for a plurality of spinning mills 2.

The spinning mill 2, the winding machine 3 and/or the winding position 31 can be equipped with at least one ambient-condition sensor (not drawn) for sensing ambient conditions of the winding position 31. Examples for ambient parameters measured by such an ambient-condition sensor are an air temperature and an air humidity. Ambient parameter values measured by the at least one ambient-condition sensor are also transmitted from the spinning mill 2 via the global communication network 6 to the server computer system 1. The server computer system 1 can use the measured ambient-parameter values for correcting the received set of values of the yarn-quality parameters to predefined ambient conditions, e.g., normal conditions, thus producing a set of corrected values. Such a correction makes the values of the yarn-quality parameters measured at different locations and/or at different times comparable to each other. The set of corrected values is stored in the database 12 on the server computer system 1 together with the assigned mill identifier, instead of or in addition to the originally received set of measured values. In the method according to this embodiment, the set of corrected values replaces the set of measured values. Hence, in the present description, the term “measured values” can be replaced by “corrected values”, unless otherwise specified.

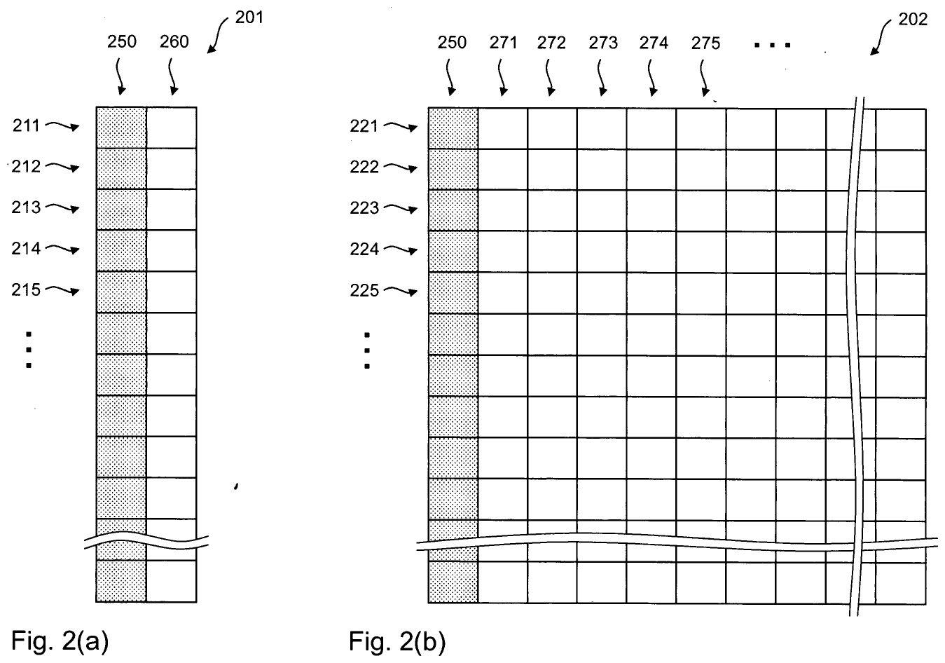

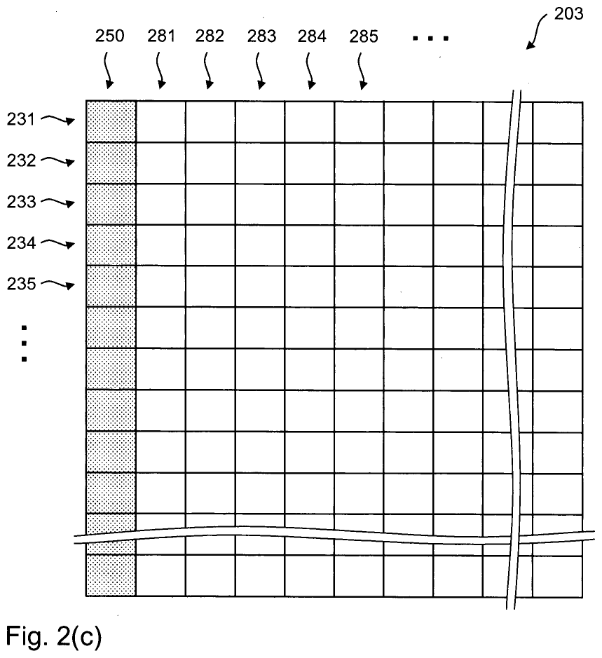

FIG. 2 schematically shows tables 201, 202, 203 of the database 12 implemented in the server computer system 1 according to the invention. Each row 211, 212, . . . ; 221, 222, . . . ; 231, 232, . . . of the tables 201-203 contains a tuple of data relating to a certain yarn package 93.

The first column 250 of the table 201 of FIG. 2(a) contains package identifiers uniquely identifying the respective yarn package 93. The second column 260 contains mill identifiers identifying the spinning mill 2 in which the respective package 93 was produced.

In the table 202 of FIG. 2(b), the first column 250 contains again the package identifiers uniquely identifying the respective yarn package 93. The second and subsequent columns 271, 272, . . . contain measured values for various yarn-quality parameters measured for yarn 92 on the respective yarn package 93.

Likewise, in the table 203 of FIG. 2(c), the first column 250 contains the package identifiers, whereas the second and subsequent columns 281, 282, . . . contain the further information on the respective yarn package 93.

In the embodiment of FIGS. 2(a)-(c), it is assumed that the package identifier is assigned biuniquely to each received set of measured values and to each received further information. Thus, the package identifiers in the first columns 250 of each table 201-203 serve as a primary key for the database 12. The rows 211, 221, 231 of the different tables 201-203 containing data related to the same yarn package 93 are linked to each other by means of the package identifier in the first columns 250 of the rows 211, 221, 231.

In an alternative embodiment, other keys can be used for linking the rows of the tables of the database 12 to each other. For instance, package identifiers can be used that are unique within a spinning mill 2, but not within the whole database 12. In this case, the two columns 250, 260 of table 201, i.e., the package identifiers and the mill identifiers, are needed to jointly form a natural alternate key for the database 12. Other types of keys are also possible.

The server computer system 1 arranges the spinning mills 2 on a scale according to the sets of measured values assigned to them. Thus, the server computer system 1 produces a ranking of the spinning mills 2 on the scale. In a first embodiment, the ranking can be produced based on all sets of measured values stored in the database 12. In a second embodiment, the ranking can be produced based on a certain number of most recent sets of measured values having the same assigned mill identifier, e.g., the last 1000 sets of measured values having the same assigned mill identifier. In a third embodiment, the ranking can be produced based on most recent sets of measured values measured in a certain period, e.g., all sets of measured values measured in the last six months.

Before storing the set of measured values in the database 12, the set of measured values is preferably compared by the server computer system 1 with sets of measured values having the same assigned mill identifier. In case of a significant difference, the set of measured values is marked as an outlier and is not considered in the ranking. A significant difference can be determined by means of statistical methods, which are well-known to the person skilled in the art. Upon occurrence of such an outlier, an outlier message identifying the outlier can be transmitted from the server computer system 1 via the global communication network 6 to the spinning mill 2 that produced the corresponding yarn package 93. When the spinning mill 2 receives the outlier message, it can investigate the causes of the outlier and take appropriate countermeasures. Such countermeasures can include, for instance, changing a setting on a machine or a sensor, or replacing a defective machine part.

Turning again to FIG. 1, a buyer transmits from a client computer 8 via a global communication network 7 to the server computer system 1 a purchase request 71 containing yarn specifications. The purchase request 71 is received by the server computer system 1. The global communication network 7 for transmitting the purchase request 71 can be the same as or differ from the global communication network 6 for transmitting the measured values of yarn-quality parameters.

In a preferred embodiment, upon receipt of the purchase request 71, the server computer system 1 retrieves or filters from the database 12 sets of yarn packages. All yarn packages 93 of each retrieved set of yarn packages fulfill the buyer's specifications and were produced in the same spinning mill 2. The server computer system 1 produces a ranking of the retrieved sets of yarn packages 93. The ranking is based on the sets of measured values assigned to the yarn packages 93 of each set of yarn packages.

The server computer system 1 produces a ranking of the spinning mills 2 according to the sets of measured values and the mill identifiers assigned to them. It transmits the ranking via the global communication network 7 to the client computer 8, which outputs it to the buyer.

In the following, a ficticious example of producing a spinning-mill ranking is given. Yarns with a yarn count of Ne 32 produced by five spinning mills M-Q are considered. The number of five is merely exemplary and in no way limiting; in general, the server computer system 1 can consider any natural number of spinning mills from the database 12. Table 1 lists coefficients of variation of five yarn-quality parameters that could be measured for the Ne 32 yarns by the spinning mills M-Q.

TABLE 1

| | Coefficient of variation of | | | | |
|---|---|---|---|---|---|
| | Coefficient | | Thick | Thin | Neps, short and |
| Spin- | of mass | Neps | places | places | long thick places, |
| ning | variation | per | per | per | thin places |
| mill | CVm | 100 km | 100 km | 100 km | (NSLT) per 100 km |
| M | 2.0 | 35 | 31 | 34 | 64 |
| N | 3.1 | 47 | 30 | 29 | 72 |
| O | 3.8 | 66 | 49 | 44 | 98 |
| P | 1.2 | 36 | 25 | 9 | 50 |
| Q | 2.4 | 60 | 45 | 25 | 93 |

Each coefficient of variation listed in Table 1 is assigned a corresponding percentile value indicating the position of the coefficient of variation within a large basic population of coefficients of variation of the same parameter. Such percentile values can be retrieved from the well-known USTER® STATISTICS, from the database 12 or from another compilation of quality parameter values. By definition, each percentile value lies within the range between 0 and 100. The lower the percentile value, the better the corresponding coefficient of variation compared to the basic population. Table 2 shows the percentile values a-e assigned to the coefficients of variation of Table 1.

TABLE 2

| | Coefficient | | Thick | Thin | Neps, short and |
|---|---|---|---|---|---|
| | of mass | Neps | places | places | long thick places, |
| Spin- | variation | per | per | per | thin places |
| ning | CVm | 100 km | 100 km | 100 km | (NSLT) per 100 km |
| mill | a | b | c | d | e |
| M | 20 | 21 | 36 | 40 | 35 |
| N | 57 | 48 | 35 | 24 | 66 |
| O | 79 | 70 | 58 | 61 | 89 |
| P | 8 | 22 | 16 | 5 | 22 |
| Q | 44 | 63 | 52 | 21 | 80 |

A ranking r can be calculated, e.g., from the percentile values a-e of Table 2, according to the following formula:

r=8.722−(0.815·log a)−(0.858·log b)−(0.472·log c)−(0.801·log d)−(0.788·log e),

wherein the notation “log” denotes the common logarithm (to base 10). The higher the ranking r, the higher the consistency of the yarn packages 93 produced in the corresponding spinning mill M-Q. The thus calculated ranking values r are listed in the second column of Table 3.

TABLE 3

| Spinning | Ranking | Ranking | Ranking | Ranking | Ranking |
|---|---|---|---|---|---|
| mill | r | r′ | r″ | r″′ | r″″ |
| M | 3.293 | 3 | ★★★ | 680 | 2 |
| N | 2.580 | 3 | ★★★ | 60 | 3 |
| O | 1.794 | 2 | ★★ | 20 | 5 |
| P | 4.648 | 5 | ★★★★★ | 100 | 1 |
| Q | 2.470 | 2 | ★★ | 40 | 4 |

Rankings other than the ranking r discussed above are possible. The formula for the ranking r given above is merely an example; the person skilled in the art is able to find other appropriate formulae. The ranking can take into account only one of the yarn-quality parameters or more than one of the yarn-quality parameters, combining them by means of arithmetical and/or logical operators. The calculation of the ranking can be based on percentile values as shown in Table 2, on the coefficients of variation as shown in Table 1, on mean values of measured parameters and/or on percentile values assigned to such mean values.

Table 3 gives examples of alternative rankings derived from the ranking r. A second ranking r′ in the third column is on a scale with natural numbers, whereas the ranking r is on a scale with rational numbers. The second ranking r′ can be derived by rounding the ranking r; moreover, it can be limited to a certain interval, e.g., to the natural numbers 1, 2, 3, 4, 5. The second ranking r′ may be simpler to grasp visually than the ranking r. However, such a simplification is at the expense of loss of information: in the example of Table 3, the spinning mills N and O, and P and Q, respectively, have the same second ranking values r′, although their original ranking values r are different.

A third ranking r″ in the fourth column of Table 3 corresponds to the second ranking r′ but represents the integer number by a corresponding number of graphical symbols, e.g., stars. Such a representation can be even simpler to grasp visually than the second ranking r′. The third ranking r″ can be interpreted as a classification system with five classes, each class being labelled by the corresponding number of stars. Each spinning mill M-Q is classified into one of the classes.

A fourth ranking r′″ is on a scale with percentile values which indicate the position of the ranking value r within a sample consisting of, e.g., the five spinning mills M-Q. For instance, a fourth ranking of r″=60 means that 60% of the sample have the same or lower ranking values r than the corresponding spinning mill N.

A fifth ranking r″″ in the sixth column of Table 3 simply depicts the order of the ranking r, 1 denoting the highest ranking value r and 5 denoting the lowest ranking value r.

The rankings r, r′, and r″ are on metric scales, indicating differences between the values. In contrast, the rankings r′″ and r″″ are on ordinal scales.

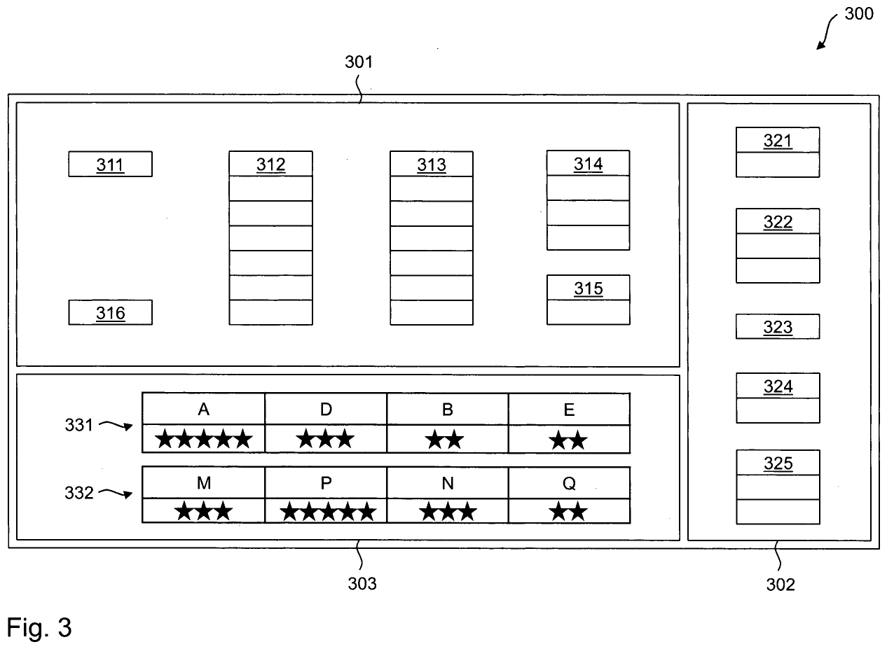

FIG. 3 shows an example of a user interface 300 outputted to a buyer by the client computer 8 on an output device, such as a display screen, connected to the client computer 8. In the example of FIG. 3, the user interface 300 is divided into three areas 301-303.

A first area 301 is for essential inputs by the buyer. Such essential inputs concern desired yarn characteristics, i.e., yarn specifications, and are preferably be submitted with the purchase request 71. They overlap or coincide with the further information stored in the database 12 for each yarn package 93. They comprise, e.g., the following.
Yarn count 311, e.g., Ne 20, Ne 30, etc.;
Yarn material 312, e.g., cotton, polyester, viscose, modal, wool, etc.;
Fiber-processing system 313, e.g., carding or combing;
Spinning system 314, e.g., ring-spun yarn, compact yarn, rotor yarn, air-jet yarn, etc.;
Envisaged application 315, e.g., knitting or weaving;
Desired amount 316 of yarn, e.g., 100 kg or 5000 km.

A second area 302 of the user interface 300 is for further inputs by the buyer. Such further inputs concern further information on the desired yarn. They can be submitted with the purchase request 71 and/or after receipt of offers 72. They comprise, e.g., the following:
Temporal availability 321 of the yarn 92, e.g., within one week or within two to three weeks;
Price 322 of the yarn 92, e.g., 0-5 USD/kg, 5-10 USD/kg, etc.;
Supplier rating 323, e.g., a rating on a five-tier scale;
Preferred yarn suppliers 324;
Preferred yarn brands 325.

A third area 303 of the user interface 300 is for outputs to the buyer. The outputs are transmitted from the server computer system 1 via the global communication network 7 to the client computer 8, the transmission being indicated by an arrow 72 in FIG. 1.

A first output in the third area 303 of the user interface 300 is a spinning-mill ranking 332 of spinning mills M, P, N, Q supplying sets of yarn packages A, D, B, E, respectively, to the buyer. The number of four is merely exemplary and in no way limiting; in general, the information sent and outputted to the buyer can consist of any natural number of spinning mills including zero. In the example of FIG. 3, the spinning-mill ranking 332 is in the form of graphical symbols as discussed above with reference to the fourth column (r″) of Table 3. It is assumed that the four sets of yarn packages A, D, B, E are offered by four different spinning mills 2; however, the same spinning mill 2 could supply more than one set of yarn packages 93.

A second output in the third area 303 of the user interface 300 includes information 331 on the four sets of yarn packages A, D, B, E supplied by the spinning mills M, P, N, Q, respectively. The information 331 relates to a natural number of sets of yarn packages best ranked in the produced yarn-package ranking described above. The sets of yarn packages A, D, B, E are preferably listed in an order according to their ranking, as shown in FIG. 3. In the example of FIG. 3, the yarn-package ranking 331 is in the form of graphical symbols, like the mill ranking r″ discussed above with reference to the fourth column of Table 3.

The example of FIG. 3 illustrates that the spinning-mill ranking 332 does not necessarily have to coincide with the yarn-package ranking 331. In the example, the spinning mill M that produced the best-ranked set of yarn packages A is not the best-ranked spinning mill. The best-ranked spinning mill P produced only the second-best-ranked set of yarn packages D. For instance, the yarn-package ranking 331 can be based on mean values of the measured quality-parameter values, whereas the spinning-mill ranking 332 can be based on coefficients of variation of the measured yarn-parameter values. Thus, the buyer can choose between the set of yarn packages A with the best mean parameter values, which, however, might have a large dispersion, and the set of yarn packages D with worse mean parameter values but a higher consistency. Of course, the buyer can as well choose the set of yarn packages B from spinning mill N or the set of yarn packages E from spinning mill Q, perhaps due to a significantly lower price and/or the yarn buyer's lower requirements related to yarn quality.

The ranking 331 of the sets of yarn packages and the ranking 332 of the spinning mills 2 facilitate the buyer's choice. The rankings 331, 332 are based on objective measurement values.

Still further information on the four sets of yarn packages A, D, B, E and/or on the spinning mills M, P, N, Q can be transmitted from the server computer system 1 to the client computer 8 and displayed to the buyer.

If the buyer is an end user of the yarn, the information received from the server computer system 1 (arrow 72 in FIG. 1) can constitute an offer from the spinning mill 2 to the buyer. After receipt of the offer 72, the buyer can choose one or several of the offered sets of yarn packages A, D, B, E and send a corresponding order from the client computer 8 via the global communication network 7 to the server computer system 1. Alternatively, the order can be placed via a buyer's enterprise-resource-planning system or a buyer's supply-chain-management system, which systems can be independent of the server computer system 1 according to the invention. The order identifies the chosen set or sets of yarn packages and indicates the ordered amount. The server computer system 1 receives the order and forwards it to the spinning mill 2 or spinning mills 2 that produced and offered the ordered set or sets of yarn packages; the forwarding of the purchase request is indicated in FIG. 1 by an arrow 62. The spinning mill 2 thereafter initiates a shipment of the ordered set of yarn packages to the buyer.

If, on the other hand, the buyer is an intermediary, it can forward the information received from the server computer system 1 to one or several of its customers (not drawn in FIG. 1), e.g., in form of an offer. The customer or customers can then place a purchase request via the intermediary and the server computer system 1 according to the invention or via an alternative route.

It is understood that the present invention is not limited to the embodiments discussed above. With knowledge of the invention, the person skilled in the art will be able to derive further variants which are also part of the subject matter of the present invention.

LIST OF REFERENCE NUMERALS

| | |
|---|---|
| 1 | Server computer system |
| 11, 13 | Communication means |
| 12 | Database |
| 2 | Spinning mill |
| 3 | Yarn-winding machine |
| 31 | Winding position |
| 4 | Yarn monitoring system |
| 41 | Yarn sensor |
| 42 | Data line |
| 43 | Yarn monitoring control unit |
| 5 | Cloud connector |
| 6 | Global communication network |
| 61 | Data transmission |
| 62 | Forwarding of purchase request |
| 7 | Global communication network |
| 71 | Purchase request |
| 72 | Information on best-ranked |
| | sets of yarn packages, offer |
| 8 | Client computer |
| 91 | Cop |
| 92 | Yarn |
| 93 | Yarn package |
| 201-203 | Tables of the database 12 |
| 211, 212, . . . | Rows of the first table 201 |
| 221, 222, . . . | Rows of the second table 202 |
| 231, 232, . . . | Rows of the third table 203 |
| 250, 260 | Columns of the first table 201 |
| 250, 271, 271, . . . | Columns of the second table 202 |
| 250, 281, 282, . . . | Columns of the third table 203 |
| 300 | User interface |
| 301-303 | Areas of the user interface 300 |
| 311 | Yarn count |
| 312 | Yarn material |
| 313 | Fiber-processing system |
| 314 | Spinning system |
| 315 | Envisaged application |
| 316 | Desired amount of yarn |
| 321 | Temporal availability of yarn |
| 322 | Desired price of yarn |
| 323 | Supplier rating |
| 324 | Preferred yarn suppliers |
| 325 | Preferred yarn brands |
| 331 | Information on sets of yarn |
| | packages, yarn-package ranking |
| 331 | Spinning-mill ranking |

1. A computer-implemented method for assessing spinning mills (2) producing yarn packages (93) on yarn-winding machines (3), comprising the steps of:
receiving by a server computer system (1) via a global communication network (6) from a spinning mill (2) having produced a yarn package (93) on a yarn-winding machine (3) a set of measured values for at least one yarn-quality parameter measured for yarn (92) on the yarn package (93) by at least one sensor (41) on the yarn-winding machine (3);
assigning by the server computer system (1) to the set of measured values a mill identifier for the respective spinning mill (2);
storing in a database (12) on the server computer system (1) the set of measured values together with the assigned mill identifier;
repeating the preceding steps for at least one other spinning mill (2);
producing by the server computer system (1) a ranking of the spinning mills (2) according to the sets of measured values and the mill identifiers assigned to them; and
transmitting the ranking from the server computer system (1) via a global communication network (7) to a client computer (8).

2. The computer-implemented method according to claim 1, wherein the set of measured values is for at least one parameter from the following set: coefficient of variation of the yarn mass, coefficient of variation of the yarn diameter, hairiness, number of thick places, number of thin places, number of periodic yarn defects, number of yarn count variations, number of foreign matters, number of splices.

3. The computer-implemented method according to claim 1, further comprising the steps of:
receiving by the server computer system (1) via the global communication network (6) from the spinning mill (2) further information on the yarn package (93);
assigning by the server computer system (1) to the further information the mill identifier for the respective spinning mill (2); and
storing in the database (12) the further information together with the assigned mill identifier.

4. The computer-implemented method according to claim 3, wherein the further information is from the following set: yarn count, yarn material, fiber processing system, spinning system, envisaged application, amount of yarn packages available, temporal availability of the yarn package, price of the yarn package.

5. The computer-implemented method according to claim 1, further comprising the steps of:
assigning by the server computer system (1) to the received set of measured values a package identifier for the respective yarn package (93); and
storing in the database (12) the package identifier together with the set of measured values and the mill identifier.

6. The computer-implemented method according to claim 5, further comprising the steps of:
receiving by the server computer system (1) via the global communication network (7) from the client computer (8) a purchase request (71) containing yarn specifications;
retrieving from the database (12), using the package identifiers and the mill identifiers, sets of yarn packages such that the further information matches the yarn specifications for all packages of each of the retrieved sets of yarn packages; and
producing by the server computer system (1) the ranking only of those spinning mills (2) that produced the retrieved sets of yarn packages.

7. The computer-implemented method according to claim 1, wherein the ranking is produced based on all sets of measured values stored in the database (12), based on a certain number of most recent sets of measured values, or based on most recent sets of measured values measured in a certain period.

8. The computer-implemented method according to claim 1, wherein the ranking is produced on an ordinal scale or on a metric scale.

9. The computer-implemented method according to claim 1, wherein the ranking is in the form of measured values assigned to the spinning mills (2), in the form of quantiles or percentiles assigned to the spinning mills (2), in the form of ordinal numbers assigned to the spinning mills (2), and/or in the form of classes into which the spinning mills (2) are classified.

10. The computer-implemented method according to claim 1, wherein, before storing the set of measured values in the database (12), the set of measured values is compared by the server computer system (1) with sets of measured values having the same assigned mill identifier, and in case of a significant deviation, the set of measured values is marked as an outlier and is not considered in the ranking.

11. The computer-implemented method according to claim 10, wherein upon occurrence of an outlier, an outlier message identifying the outlier is transmitted from the server computer system (1) via the global communication network (6) to the respective spinning mill (2).

12. The computer-implemented method according to claim 1, further comprising the steps of:
receiving by the server computer system (1) via the global communication network from the spinning mill (2) values of at least one ambient parameter characteristic for an ambient condition of a location and a time of winding the yarn package (93);
correcting by the server computer system (1) the received set of measured values to predefined ambient conditions based on the received value of the at least one ambient parameter, thus generating a set of corrected values; and
replacing in the method according to any one of the preceding claims the set of measured values by the set of corrected values.

13. A server computer system (1) comprising means for carrying out the method according to claim 1.

14. A computer program having instructions which when executed by a server computer system (1) cause the server computer system (1) to perform the method according to claim 1.

15. A server computer system (1) for assessing spinning mills (2) producing yarn packages (93) on yarn-winding machines (3), comprising:
a receiver (11) for receiving via a global communication network (6) from at least two spinning mills (2) having produced yarn packages (93) on yarn winding machines (3) sets of measured values for at least one yarn-quality parameter measured for yarn (92) on each of the yarn packages (93) by at least one sensor (41) on the respective yarn-winding machine (3);
a processor configured to assign to each set of measured values a mill identifier for the respective spinning mill (2);
a memory for storing in a database (12) the sets of measured values together with the assigned mill identifiers;
a processor configured to produce a ranking of the at least two spinning mills (2) according to the sets of measured values and the mill identifiers assigned to them; and
a transmitter for transmitting the ranking via a global communication network (7) to a client computer (8).
